(19) United States
(12) Patent Application Publication
(10) Pub. No.: US 2012/0256351 A1
(43) Pub. Date: Oct. 11, 2012

(54) METHOD FOR MANUFACTURING HOLLOW BRICKS

(76) Inventor: Ying-Yun CHEN, Yunlin County (TW)

(21) Appl. No.: 13/083,164

(22) Filed: Apr. 8, 2011

(51) Int. Cl. B28B 7/18

(52) U.S. Cl. 264/336

(57) ABSTRACT

A method for manufacturing hollow bricks comprises following steps: providing a frame-shape mold with at least a cavity and placing it on a flat surface; inserting at least one mold insert transversely through the cavity of the frame-shape mold and loading material into the cavity; and forming a billet of a hollow brick by moving an upper die downward to press the material. Besides, the frame-shape mold and the billets of hollow bricks can be separated from each other by lifting the upper die, moving the mold insert out of the cavity, and moving the frame-shape mold. The billet of the hollow brick that is taken out is dried to form a hollow brick having a certain height and can be used in hollow-brick wall construction.

### TECHNICAL FIELD

The present invention relates to a method for manufacturing hollow bricks and, more particularly, to a method for manufacturing hollow bricks by which it is able to manufacture hollow bricks with a uniform height so as to accelerate the construction of a hollow brick wall and lower the construction cost.

### BACKGROUND

Please refer to FIG. 6, in which a conventionally used hollow brick “a” is demonstrated. The hollow brick is manufactured by a method comprising following steps: placing a frame mold having plural cavities on a plat surface; loading the mixture of cement, gravel sands, and water downwards into the cavities; utilizing a upper die to compress the mixture downwards after the loading step for forming billets of hollow bricks; proceeding drying procedure to form usable products having sufficient strength.

As shown in FIG. 7, when above hollow bricks “a” are used for construction, one hollow brick “a” is conventionally connected with another hollow brick “a” via cement-sand slurry. Afterwards, a wire mesh for reinforcement “b” is horizontally placed between every two layers of hollow bricks “a”. Finally, these hollow bricks “a” are positioned by alternatively placing steel bars and proceeding grouting procedure. In this case, the cement-sand slurry is mainly used for temporary positioning each hollow brick “a”, and the main connection force for the hollow bricks “a” comes from the cooperation of the horizontal wire mesh “b”, steel bars, and grouting.

Besides, the allowable error for the hollow brick “a” manufactured by above method of manufacturing hollow brick is ±2 mm. In other words, the error for length, width, and height must be within ±2 mm. During the building of a brick wall, that each hollow brick has different length and width has no influence on the construction of the wall. However, as shown in FIG. 8, when the used hollow bricks “a” do not have uniform height, it is necessary to make the hollow bricks “a” to be of uniform height by adopting heavy and accurate filling work performed by skilled workers. In this way, the construction cost is inevitably increased.

Moreover, by above method for manufacturing hollow bricks, it is only capable of forming simple lines or patterns on lateral side of each hollow brick “a” used for building a wall. It is unable to form diversified patterns or to from waterproof layer on the lateral side of each hollow brick simultaneously in the process of manufacturing hollow bricks.

In order to overcome above shortcomings, inventor had the motive to study and develop the present invention to provide a method for manufacturing hollow bricks, which is different from conventional methods, and is capable of producing hollow bricks with uniform height in order to lowering the cost of brick wall construction and forming diversified patterns or waterproof layer on lateral side of the produced hollow bricks.

### SUMMARY OF THE DISCLOSURE

An object of the present invention is to provide a method for massively manufacturing hollow bricks having uniform height. Thereby, it is capable of accelerating the construction of hollow-brick wall and of lowering the construction cost.

Another object of the present invention is to provide a method for manufacturing hollow bricks, where it is able to form diversified patterns or waterproof layer on lateral side of the produced hollow bricks. Thereby, the hollow-brick wall built by the hollow bricks can be provided with beautiful surface in one processing. In other words, it is able to save the time or cost required for another additional processing.

In order to achieve above objects, the present invention provides a method for manufacturing hollow bricks comprising following steps: a. providing a frame-shape mold with at least a cavity and placing it on a flat surface; b. inserting at least one mold insert transversely through the cavity of the frame-shape mold; c. loading material into the cavity, and forming a billet of a hollow brick by moving an upper die downward to press the material; d. lifting the upper die and moving the mold insert out of the cavity; and e. moving the frame-shape mold to separate the frame-shape mold from the billet of the hollow brick, and taking out and drying the billet of the hollow brick to fix its shape.

In implementation, the method for manufacturing hollow bricks of the present invention further comprises a step of: vibrating the frame-shape mold to tamp the material after the material is loaded into the cavity.

In implementation, the material is a mixture of cement, gravel sands, and water.

In implementation, the method for manufacturing hollow bricks of the present invention further comprises a step of: loading a layer of outside material to have the outside material combined onto a top of the hollow brick after the billet of the hollow brick is formed.

The following detailed description, given by way of examples or embodiments, will best be understood in conjunction with the accompanying drawings.

### BRIEF DESCRIPTION OF THE DRAWINGS

FIG. 1 shows a flowchart in a preferred embodiment of the present invention.

FIG. 2 is a perspective view showing each element required in the preferred embodiment of the present invention.

FIG. 3 is a perspective view showing the billet of a hollow brick manufactured by using the method of the present invention.

FIG. 4 is a using state diagram of the hollow bricks manufactured by using the method of the present invention.

FIG. 5 is a perspective view showing a hollow brick in the preferred embodiment, which is manufactured by the method further comprising a step of loading a layer of outside material.

FIG. 6 is a perspective view showing a conventional hollow brick.

FIG. 7 is a schematic view showing the building of a conventional hollow-brick wall.

FIG. 8 is a perspective view showing that hollow bricks are arranged to form a conventional hollow-brick wall.

### DETAILED DESCRIPTION

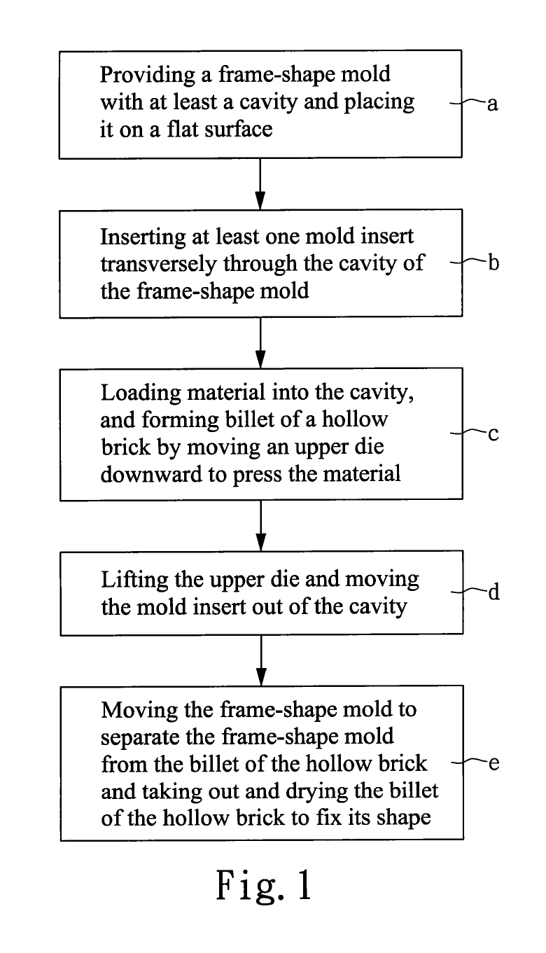

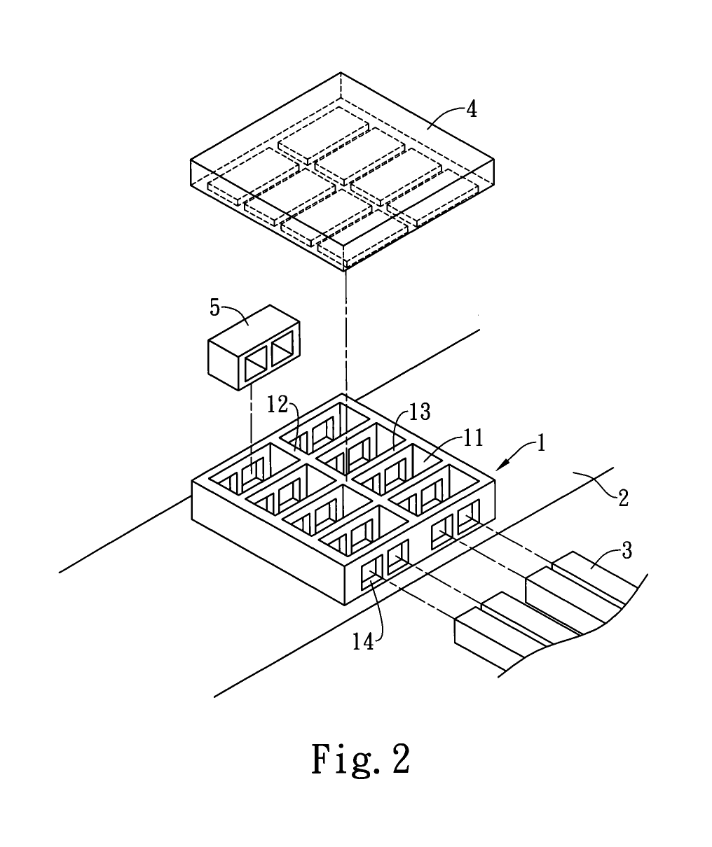

Please refer to FIG. 1, which shows a preferred embodiment of a method for manufacturing hollow bricks according to the present invention. As shown in FIG. 2, each element provided is required in this embodiment. The method used in this embodiment comprises step of:
a. providing a frame-shape mold 1 with cavities 11 and placing the frame-shape mold 1 on a flat surface 2;
b. inserting at least one mold insert 3 transversely through the cavities 11 of the frame-shape mold 1;
c. loading material into the cavities 11, and forming a billet 5 of a hollow brick by moving an upper die 4 downward to press the material;
d. lifting the upper die 4 and moving the mold insert 3 out of the cavity; and
e. moving the frame-shape mold 1 to separate the frame-shape mold 1 from the billet of the hollow brick, and taking out and drying the billet 5 of the hollow brick to fix its shape.

As shown in FIG. 2, the surface 2 in step “a” is part of a conveyor belt and the conveyor belt is driven by a driver to begin a one-way rotational movement. The surface 2 also can be part of a fixed machine on which the frame-shape mold 1 is placed. The frame-shape mold 1 is generally in the shape of grid network and mainly includes a plurality of longitudinal upright plates 12 and a plurality of transverse upright plates 13 that are vertical to the longitudinal upright plates. These plates define a plurality of rectangular cavities 11. The plural transverse upright plates 13 defining each cavity 11 are respectively provided with two rectangular holes 14. In implementation, one, two, or more holes 14 can be provided. In addition, the holes 14 can be in round shape or in other geometrical shape.

In this embodiment, four mold inserts 3 are provided in step “b” respectively corresponding to the rectangular shape of the holes 14 and are inserted through the holes 14 and the cavities 11 of the frame-shape mold 1. Thereby, two mold inserts 3 can be placed in any one transversely arranged cavity 11 of the frame-shape mold 1.

In step “c”, after the mixture of cement, gravel sands, and water are loaded from the top of the frame-shape mold 1 into the cavities 11, an upper die 4 is used to press downwards the mixture in order to form plural billets 5 of hollow bricks. In implementation, a vibration step can be further included in step “c”: vibrating the frame-shape mold 1 to tamp the mixture after the mixture is loaded into the cavities 11 so as to ensure that the structure of the billets 5 of hollow bricks is compact. On the bottom surface of the upper die 4 can be provided with a pattern. Thereby, the top surface of the billets 5 of hollow bricks can be formed with that pattern by moving the upper die downwards to press the top surface.

In steps “d” and “e”, the frame-shape mold 1 and the billets 5 of hollow bricks can be separated by lifting the upper die 4 upwards, taking out the mold insert 3 transversely, and moving the frame-shape mold 1 upwards. By means of the conveyor belt, the billets 5 of hollow bricks can be move forward to be dried and shaped. After the billets 5 of hollow bricks are moved forward, steps “a” to “e” are repeated in order to form another set of billets 5 of hollow bricks. The billets 5 of hollow bricks manufactured by above method are arranged horizontally. Because the cavities 11 of the frame-shape mold 1 are of the same fixed shape, each horizontally arranged billet 5 of hollow brick is of the same height.

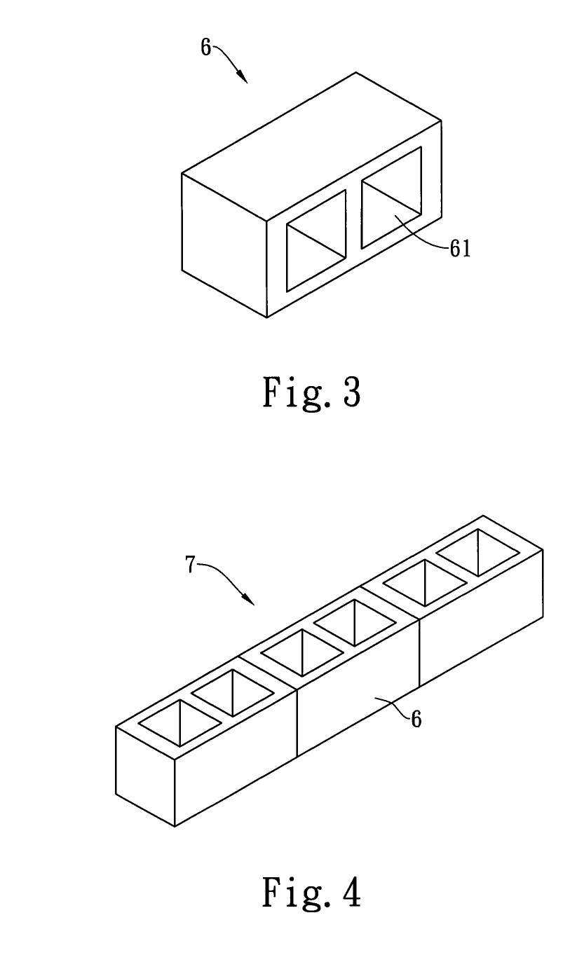

As shown in FIG. 3, the hollow bricks 6 manufactured by above steps is arranged in a direction different from that of the hollow bricks 6 of hollow-brick wall 7 shown in FIG. 4. In other words, of the hollow brick 6 manufactured by the method of the present invention the hole 61 horizontally passes through the hollow brick 6. Therefore, being used in the building of a hollow-brick wall 7, the originally horizontally arranged hollow brick 6 should be turned 90 degrees so as to have the holes 61 vertically pass through the hollow brick 6.

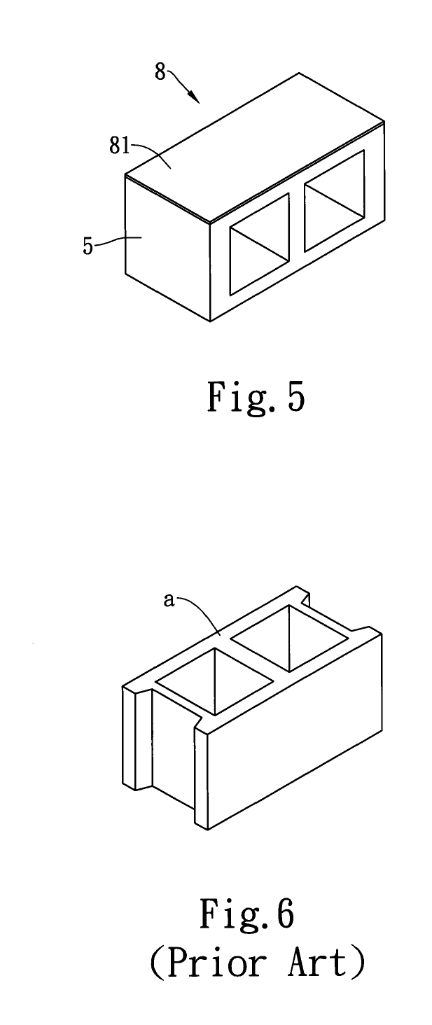

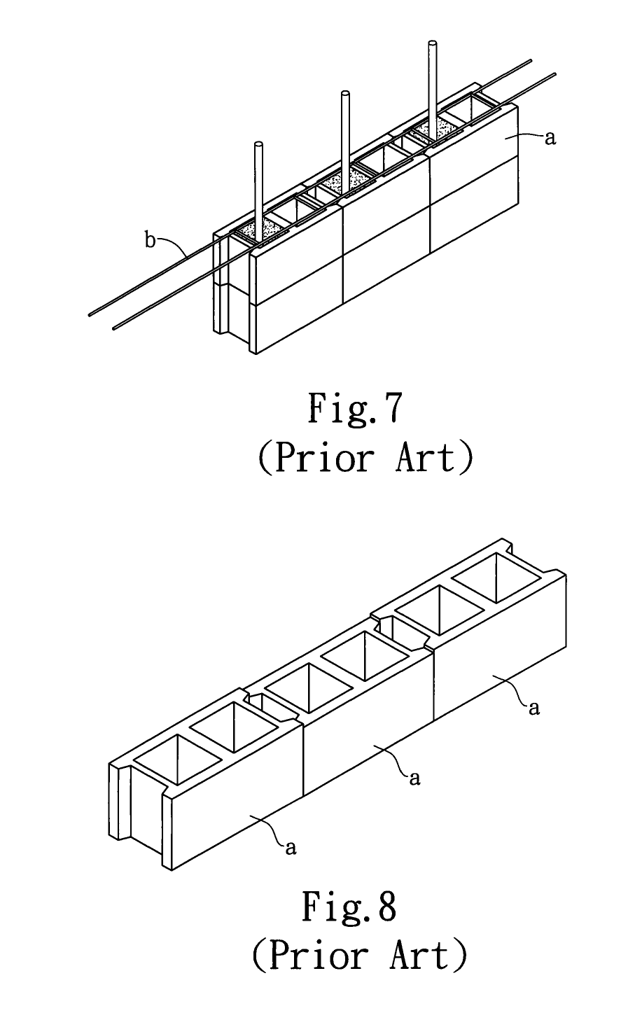

Please refer to FIG. 5, which shows a hollow brick 8 manufactured by the method further comprising an additional step of loading outside material following step “c”. This additional step is as follows: after the billet 5 of the hollow brick is formed, loading a layer of outside material 81 to have the outside material combined onto or penetrated into a top surface of the hollow brick's billet 5. In implementation, the outside material can be a water repellent. Moreover, the outside material also can be of pigments or decorative material. Thereby, it is able to form diversified patterns on a side of a hollow-brick wall built by these hollow bricks 8.

Therefore, the present invention has following advantages:
1. According to the present invention, it is able to manufacture hollow bricks having uniform height. Thereby, during the building of a hollow brick wall, it is not required to adjust the height of each hollow brick, so that the construction can be accelerated and the construction cost can be cut down.
2. According to the present invention, it is able to form diversified patterns, colors, or a waterproof layer on a side of the hollow brick. Thereby, the hollow brick can be given more diversified appearance so as to increase the value in use. Moreover, time and cost also can be saved since no additional processing is required for forming above patterns, colors, or a waterproof layer.

As disclosed in above descriptions and attached drawings, the present invention can achieve desired objects to provide a method for manufacturing hollow bricks, by which it is able to manufacture hollow bricks with a uniform height, to lower the cost for building a hollow brick wall, and to form diversified patterns, colors, or a waterproof layer on the side of hollow bricks. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A method for manufacturing hollow bricks, comprising following steps:
a. providing a frame-shape mold with at least a cavity and placing it on a flat surface;
b. inserting at least one mold insert transversely through the cavity of the frame-shape mold;
c. loading material into the cavity, and forming a billet of a hollow brick by moving an upper die downward to press the material;
d. lifting the upper die and moving the mold insert out of the cavity; and
e. moving the frame-shape mold to separate the frame-shape mold from the billet of the hollow brick, and taking out and drying the billet of the hollow brick to fix its shape.

2. The method for manufacturing hollow bricks as claimed in claim 1, wherein the material is a mixture of cement, gravel sands, and water.

3. The method for manufacturing hollow bricks as claimed in claim 2, further comprising a step of: loading a layer of outside material to have the outside material combined onto a top of the hollow brick after the billet of the hollow brick is formed.

4. The method for manufacturing hollow bricks as claimed in claim 3, wherein the outside material is a water repellent.

5. The method for manufacturing hollow bricks as claimed in claim 1, wherein the flat surface is part of a conveyor belt.

6. The method for manufacturing hollow bricks as claimed in claim 5, wherein the material is a mixture of cement, gravel sands, and water.

7. The method for manufacturing hollow bricks as claimed in claim 6, further comprising a step of: loading a layer of outside material to have the outside material combined onto a top of the hollow brick after the billet of the hollow brick is formed.

8. The method for manufacturing hollow bricks as claimed in claim 7, wherein the outside material is a water repellent.

9. The method for manufacturing hollow bricks as claimed in claim 1, further comprising a step of: vibrating the frame-shape mold to tamp the material after the material is loaded into the cavity.

10. The method for manufacturing hollow bricks as claimed in claim 9, wherein the material is a mixture of cement, gravel sands, and water.

11. The method for manufacturing hollow bricks as claimed in claim 10, further comprising a step of: loading a layer of outside material to have the outside material combined onto a top of the hollow brick after the billet of the hollow brick is formed.

12. The method for manufacturing hollow bricks as claimed in claim 11, wherein the outside material is a water repellent.
